(19) United States
(12) Patent Application Publication
(10) Pub. No.: US 2009/0117514 A1
(43) Pub. Date: May 7, 2009

(54) METHOD AND COMPONENTS FOR PRODUCING EDENTULOUS DENTURES

(75) Inventor: Joseph J. Massad, Tulsa, OK (US)

Correspondence Address: HEAD, JOHNSON & KACHIGIAN, 228 W 17TH PLACE, TULSA, OK, 74119, US

(73) Assignee: Global Dental Impression Trays, Inc., Tulsa, OK (US)

(21) Appl. No.: 12/108,075

(22) Filed: Apr. 23, 2008

Related U.S. Application Data
(60) Provisional application No. 60/986,142, filed on Nov. 7, 2007.

(51) Int. Cl. A61C 13/20

(52) U.S. Cl. 433/39

(57) ABSTRACT

A method and component devices for producing edentulous dentures. The method includes obtaining a cast impression of a jaw, any teeth and gingiva area with a first set of dental trays including selecting a properly sized upper dental tray and a properly sized lower dental tray, applying impression material in each said tray and placing each said dental impression tray with said impression material in said oral cavity in order to deform uncured impression material. A second set of dental trays is utilized including a lower dental tray having a contact plate with an upwardly extending shoulder surrounding a tapered opening, a ball nut retained in the tapered opening, and a post adjustably secured to the ball nut. A striking plate is attached to a second upper dental tray in order to accurately obtain an established occlusal vertical and centric relation positions. A third upper dental tray with a wax impression is inserted for esthetic blue printing to establish the shape of the patient's upper lip and mouth. A third lower dental tray with wax impression material is utilized to determine functional position including tongue, cheek and lip positioning.

### CROSS-REFERENCE TO RELATED APPLICATION

This application claims priority to U.S. Provisional Application No. 60/986,142, filed Nov. 7, 2007.

### BACKGROUND OF THE INVENTION

1. Field of the Invention

The present invention relates to a method or procedure and components or devices therefor to obtain accurate measurements and calibrations in order to produce dentures for edentulous patients. In particular, the present invention is directed to a method or procedure which will reduce the number of visits required in order to obtain the required measurements and calibrations while not eliminating detail of records in order to produce a set of dentures and will also reduce the required inventory of components to obtain the required measurements and calibrations.

2. Prior Art

Treatment of patients that are missing teeth is often accomplished by complete dentures including an upper denture and a lower denture or is accomplished by partial dentures. Prior to making new or replacement dentures, multiple measurements and calibrations are taken of the patient and of the patient's mouth and any existing dental prostheses are recorded. Additionally, appropriate measurements are taken to verify the proper fit and relationships of the dental prostheses not only with the oral cavity but with each other.

Each patient's jaws and teeth vary in size and shape. For example, some patients have large maxillary jaws and small mandibular jaws or vice versa. Ideally, dentures should mate with the mouth and function with existing mouth tissue. Objectives of dentures include retention against removal, stability, and support. Poor fitting dentures can cause mouth soreness and can negatively influence a patient's facial appearance and even a patient's diet. The production of accurate partial or complete dentures is known to require multiple measurements and multiple calibrations.

In existing practice, an impression is used to create an imprinted likeness of a jaw, any teeth and any implants, along with gingiva areas of the oral cavity. An upper tray and a lower tray are selected by size and filled with impression material, such as a resin. Since different size trays are utilized, the dentist must stock an inventory of different size trays.

The trays and impression material are then inserted into the mouth of a patient. From this impression, an acrylic or stone laboratory analogue or cast is made. Production of dentures requires additional considerations.

Additional measurements and calibrations include establishing the centric position or repentable horizontal and vertical spacing. Identifying and measuring appropriate occlusal vertical dimensions and centric relation positions during treatment of edentulous patients is also necessary for predictable and successful application of dental prostheses.

Additional measurements include esthetic blue printing to accommodate the shape of the patient's upper lip and mouth. This imprint is used to guide the laboratory in both cosmetic and tooth set up.

Additionally, dentures are designed so that their occlusal surfaces permit functional movements of the mandible. This is accomplished by arrangement of the artificial teeth to occupy a neutral zone in the mouth so the teeth will occupy a space determined by the functional balance of the oro facial and tongue musculature. A set of measurements known as “neutral zone technique” will accommodate measurement of the functional tongue, cheek and lip positioning of the patient.

Finally, an articulator or other similar device is often utilized to determine the position of the dental arches with respect to the jaws of the patient.

It would be desirable to establish a new procedure to obtain a series of measurements and calibrations of a patient to produce dentures in order to reduce the number of visits that the patient is required to make to the dental professional.

It would also be desirable to establish a new procedure to take multiple measurements and calibrations in a single patient fitting in order to produce a set of dentures.

It would also be desirable to establish a new procedure with dental trays that may be used for multiple types of measurements and calibrations.

It would also be desirable to reduce the required inventory of different types of dental trays which are necessary in order to produce a set of dentures.

### BRIEF DESCRIPTION OF THE DRAWINGS

FIGS. 1 through 12 illustrate a first set of dental trays utilized with the method and components for producing edentulous dentures as set forth in the present invention;

FIGS. 13 through 22 illustrate a second set of dental trays with the method and components as set forth in accordance with the present invention; and

FIGS. 23 through 30 illustrate a third set of dental trays utilized with the method and components as set forth in accordance with the present invention.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

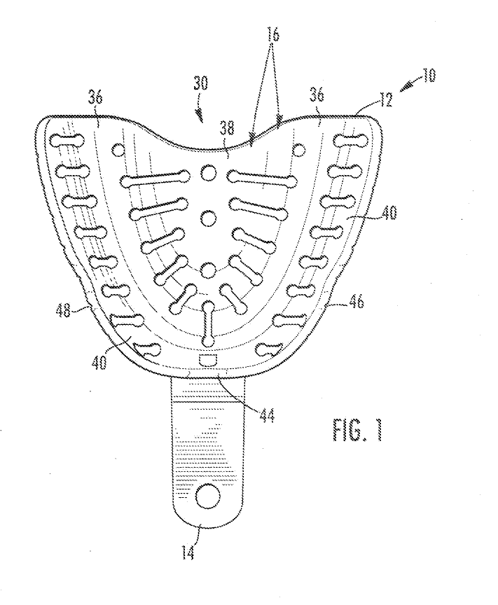

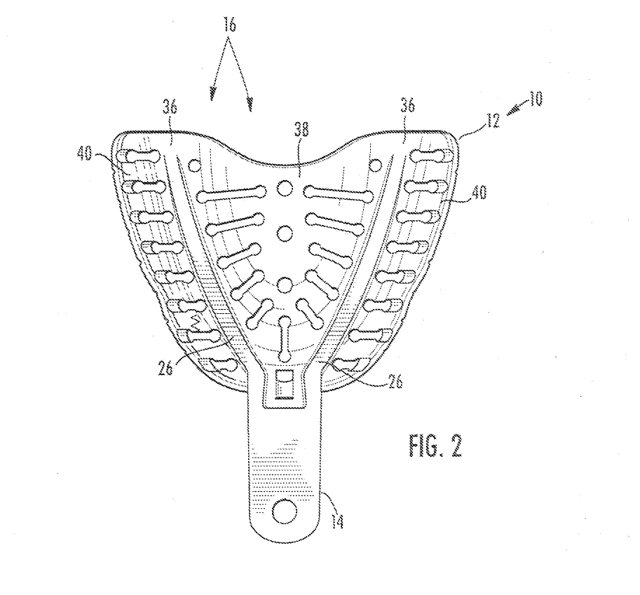

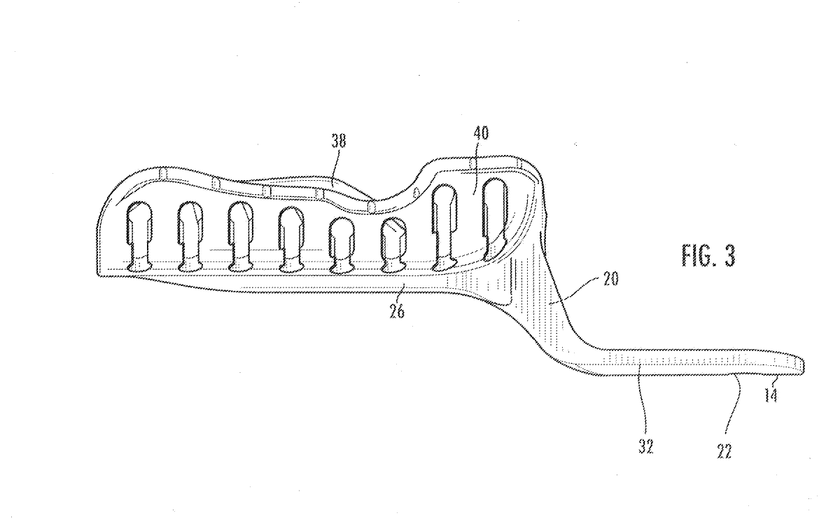

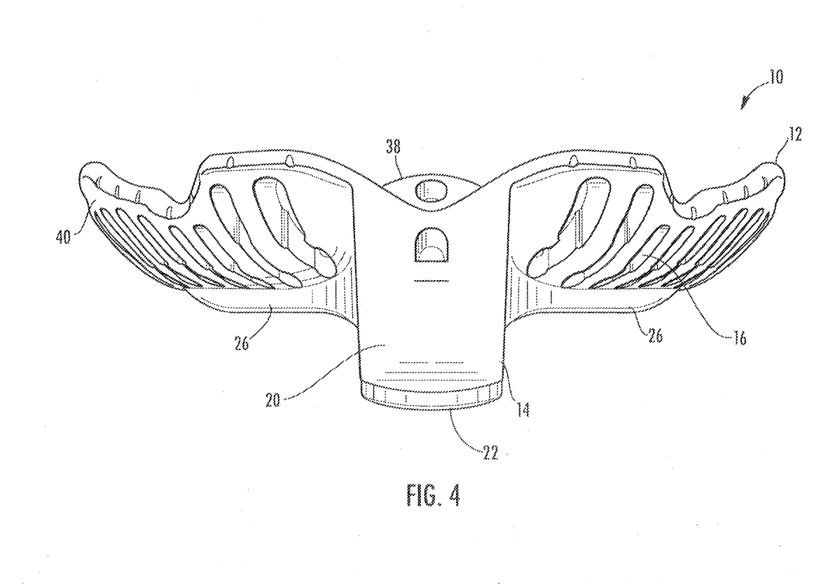

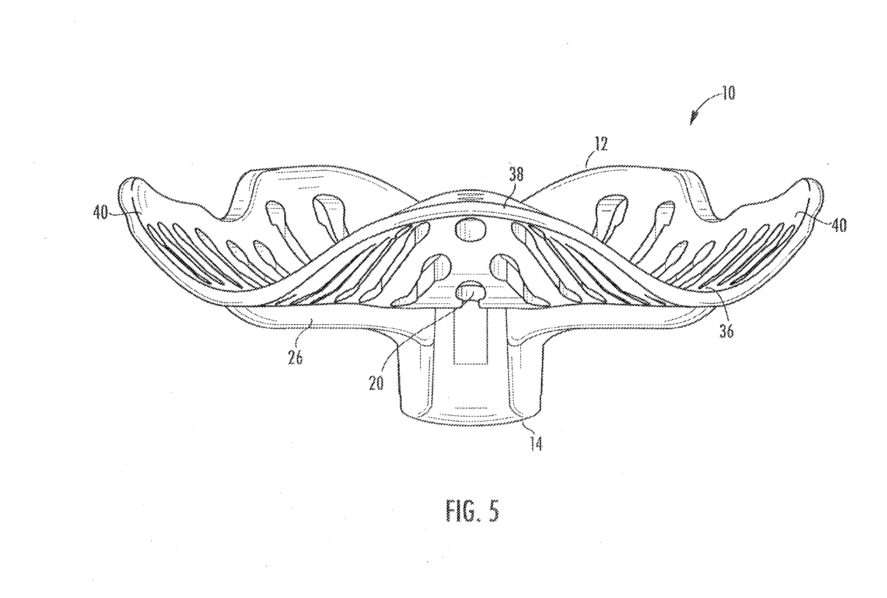

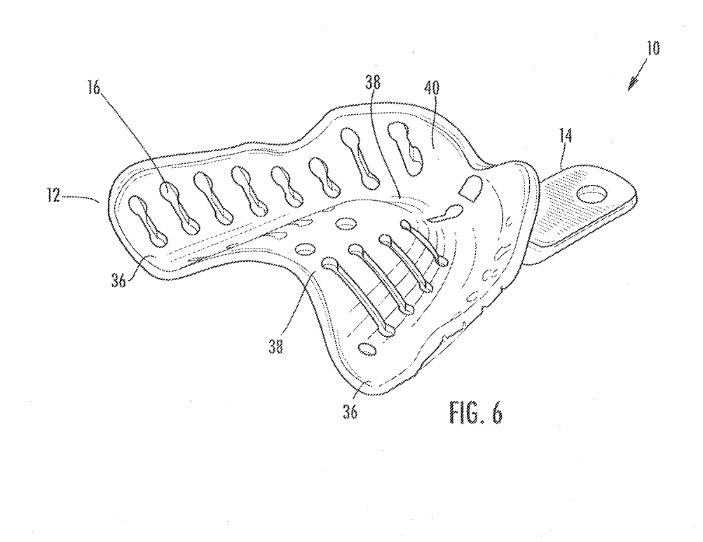

FIGS. 1 through 6 illustrate alternate views of a first upper dental tray 10 to be used to obtain a cast impression of a jaw, any teeth, and gingiva area in the oral cavity of a patient. The dental tray 10 includes a body 12, at least two finger rest beams 26, and an extending handle section 14. At least the body 12 of the upper dental tray 10 is fabricated from a heat moldable thermoplastic material that may be locally reshaped by the dentist or dental technician.

A plurality of body openings 16 have a variety of sizes and orientations depending on the location of the upper dental tray 10.

The body 12 includes an upstanding wall portion 40, a channel portion 36, and a central support portion 38.

The upper dental tray 10 includes a mechanism for insertion and removal of the dental tray comprising a handle section 32, a transition section 20, a shelf section 22, and a means for reinforcement of the shelf section 38. The shelf section 22 is somewhat parallel to but offset from the body 12.

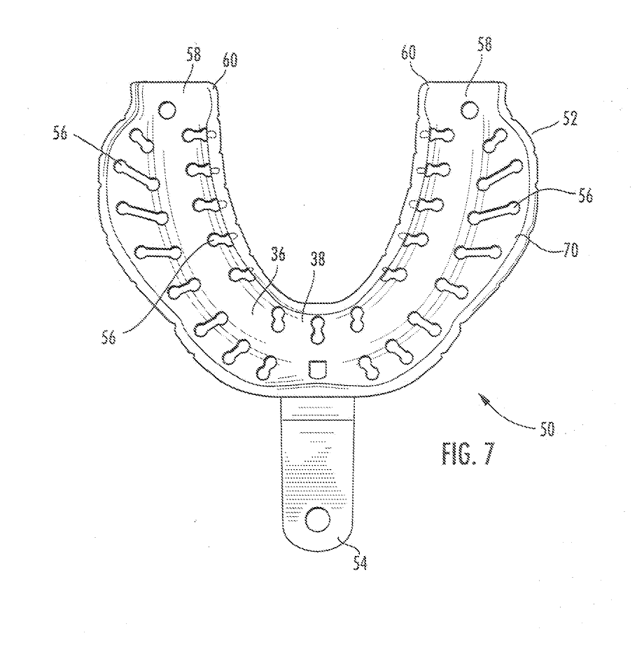

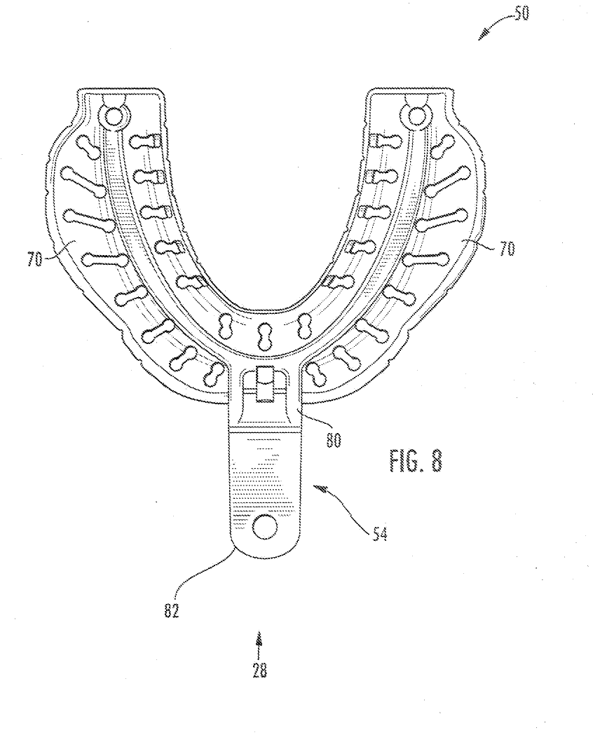

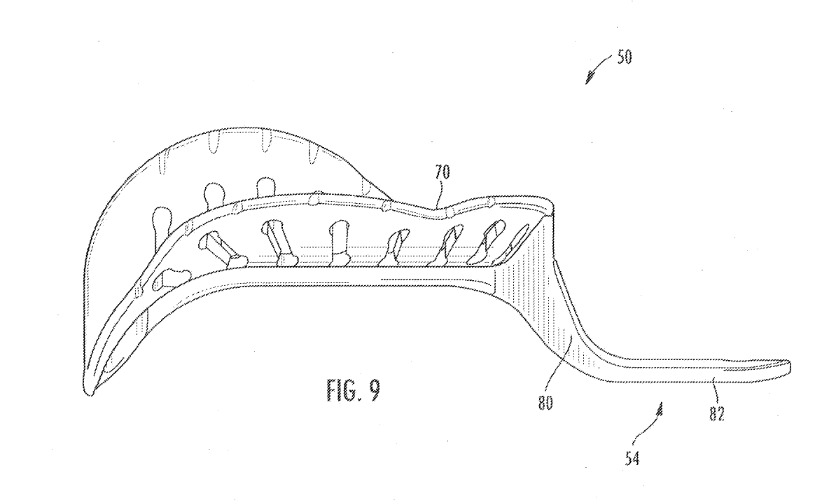

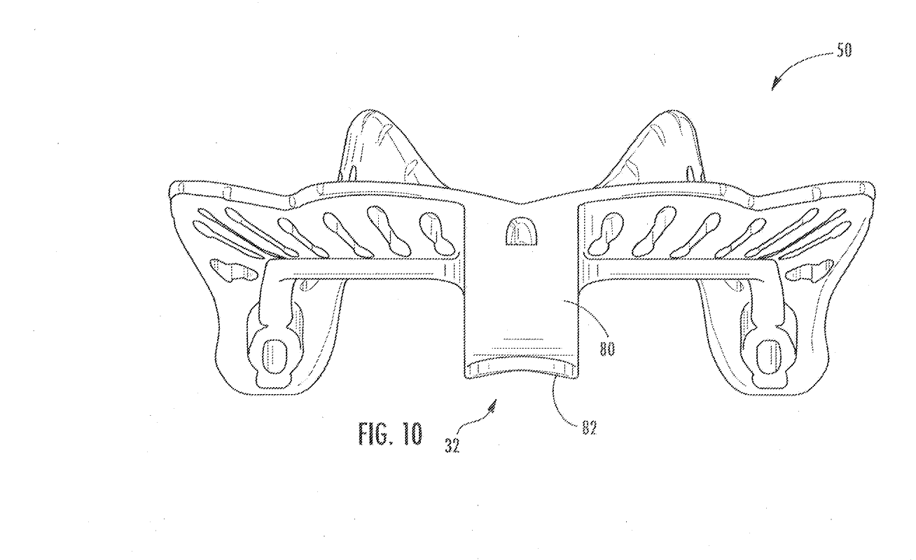

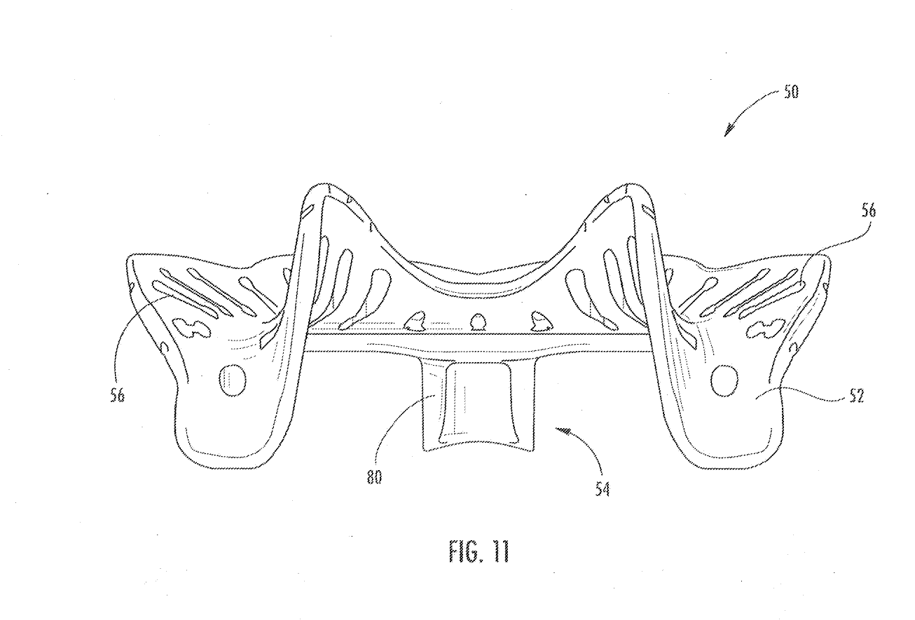

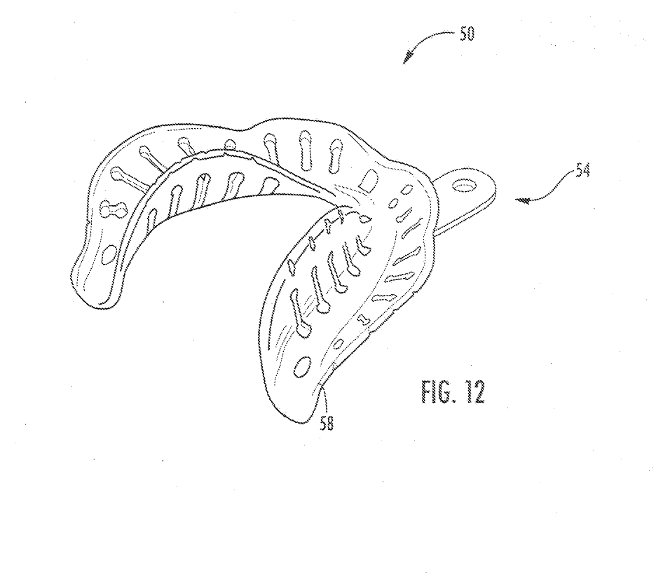

FIGS. 7 through 12 illustrate alternate views of a first lower dental tray 50 to be used to obtain a cast impression of a jaw, any teeth, and gingiva area in the oral cavity of a patient.

A first lower tray 50 includes a body 52, at least two finger rest beams 66, and an extending handle 54. At least the body 52 of the lower dental tray 50 is fabricated from a heat moldable thermoplastic material that may be locally reshaped by the dentist or dental technician.

A plurality of body openings 56 have a variety of sizes and orientations depending on the location of the lower dental tray 50.

The body 52 includes an upstanding wall portion 70, a channel portion 58 and a central support portion 60.

The first lower dental tray 50 includes a mechanism for insertion and removal of the dental tray comprising a handle 54, a transition section 80, a shelf section 82 and a means for reinforcement of the shelf section.

In order to use the first set of dental trays, a proper sized dental tray 10 or 50 is selected to obtain the impression and fit within the oral cavity of the patient. For example, the dental trays 10 and 50 may be in small, medium, and large sizes. Impression material is selected with desired curing properties. The impression material is applied to the peripheral of the dental tray. The dental tray with the impression material is then inserted into the oral cavity with the handle extending outwardly. The dental tray and impression material is held in position which causes the impression material to flow through the plurality of openings in the body while performing functional movements of the patient. The dental tray and impression material is held in place until the impression material at least partially cures. Thereafter, a cast impression may then be made. The exact same procedure is performed for both the upper and the lower trays.

The first set of dental trays 10 and 50 and their use is explained in detail in Applicant's co-pending U.S. patent application Ser. No. 11/680,992, which is incorporated herein by reference.

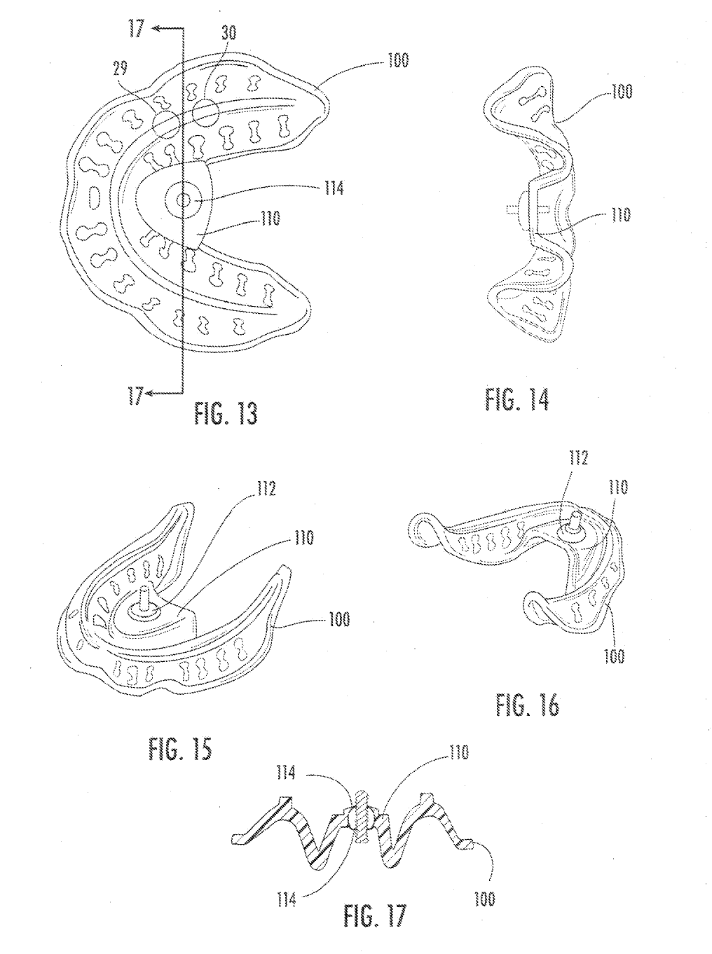

Once the first set of dental trays 10 and 50 has been utilized and removed from the oral cavity, a second set of dental trays as shown in FIGS. 13 through 22 is utilized. A second lower dental tray 100 is shown in alternate views in FIGS. 13 through 17. The second lower dental tray 100 may come in multiple sizes, such as small, medium, and large. The lower dental tray 100 includes a contact plate 110 secured to and attached to the upper dental tray 100. The contact plate 110 may be integral with and secured to the lower dental tray 100 or may be snap or friction fit to the tray 100 so that the contact plate 110 may be added or removed as needed.

The contact plate 110 includes an upwardly extending shoulder 112 which surrounds a tapered opening in the contact plate 110. A ball nut 114 is retained in the tapered opening. The ball nut 114 resides snugly in the tapered opening but will permit the ball nut to rotate within the opening upon force from the dentist or technician. Accordingly, the ball nut 114 may be positioned angularly as desired. A post 116 having external threads is adjustably secured to internal threads on the ball nut 114 so that the length of the post and the angular position of the post 116 may be altered depending on the patient.

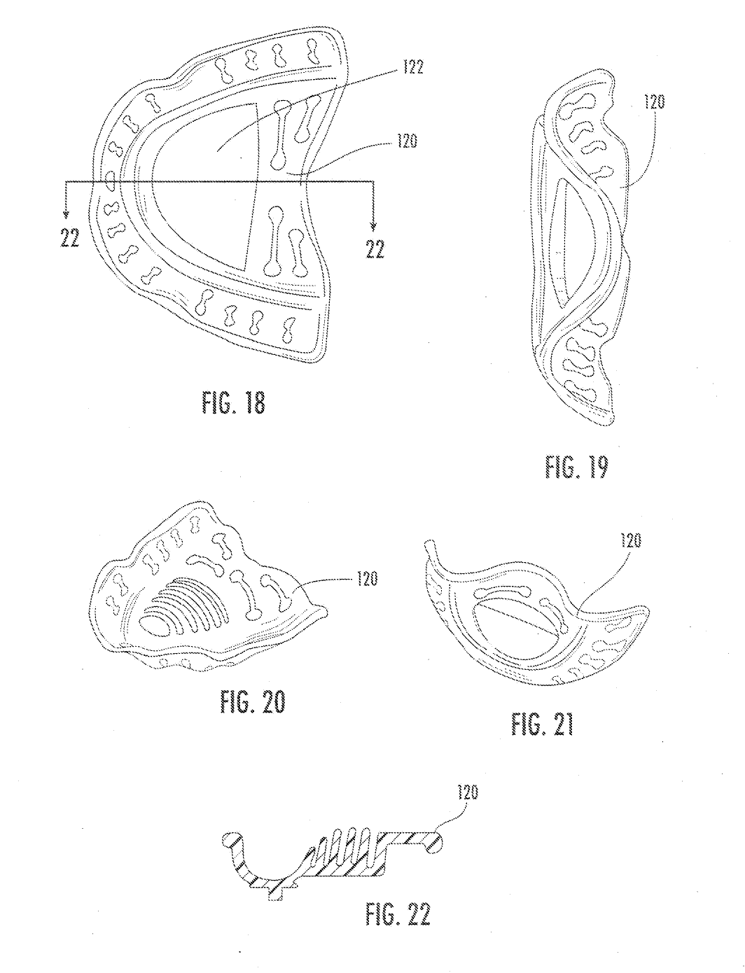

As seen in the alternate views in FIGS. 18 through 22, a second upper dental tray 120 includes a striking plate 122 which is attached to the second upper dental tray. The second upper dental tray 120 may come in multiple sizes, such as small, medium and large.

The striking plate 122 may be integral with and secured to the upper tray 120 or may be snap or friction fit to the tray 120 so that the striking plate may be added or removed as needed. The combination of the post 116 on the lower tray and the striking plate 122 on the upper dental tray are utilized to obtain and establish a proper occlusal vertical and centric relation positions. The occlusal device for diagnostic evaluation is described in detail in Applicant's co-pending patent application Ser. No. 11/754,009, which is incorporated herein by reference. Once these positions have been established, the second set of dental trays 100 and 120 is removed.

A third set of dental trays is then utilized. An important feature of the present invention is that the same second set of trays may be used in the third procedure. Accordingly, the same second upper and lower trays 100 and 120 may be used.

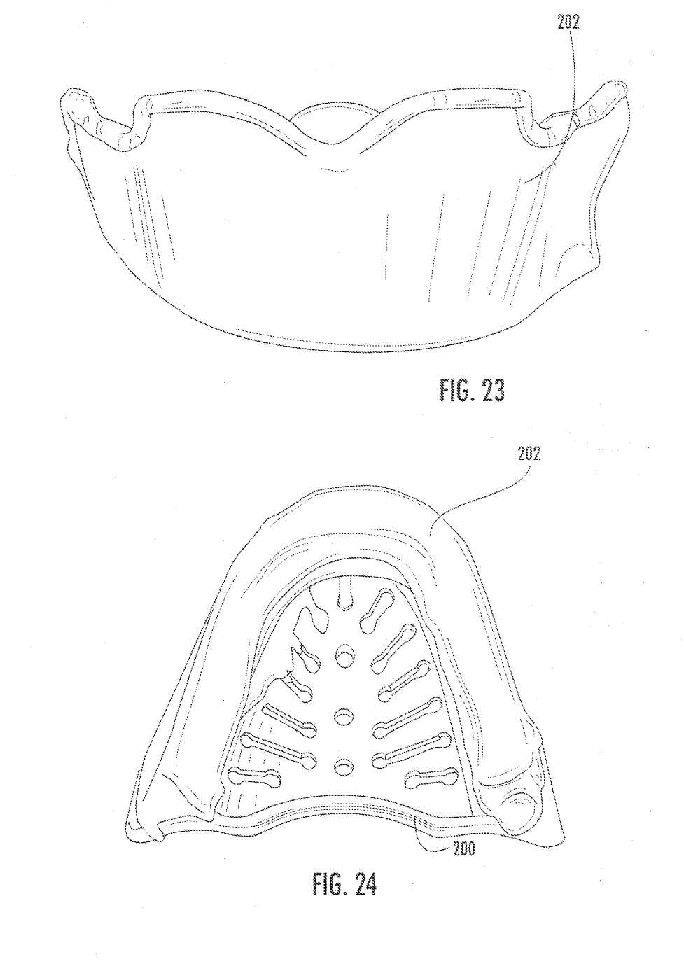

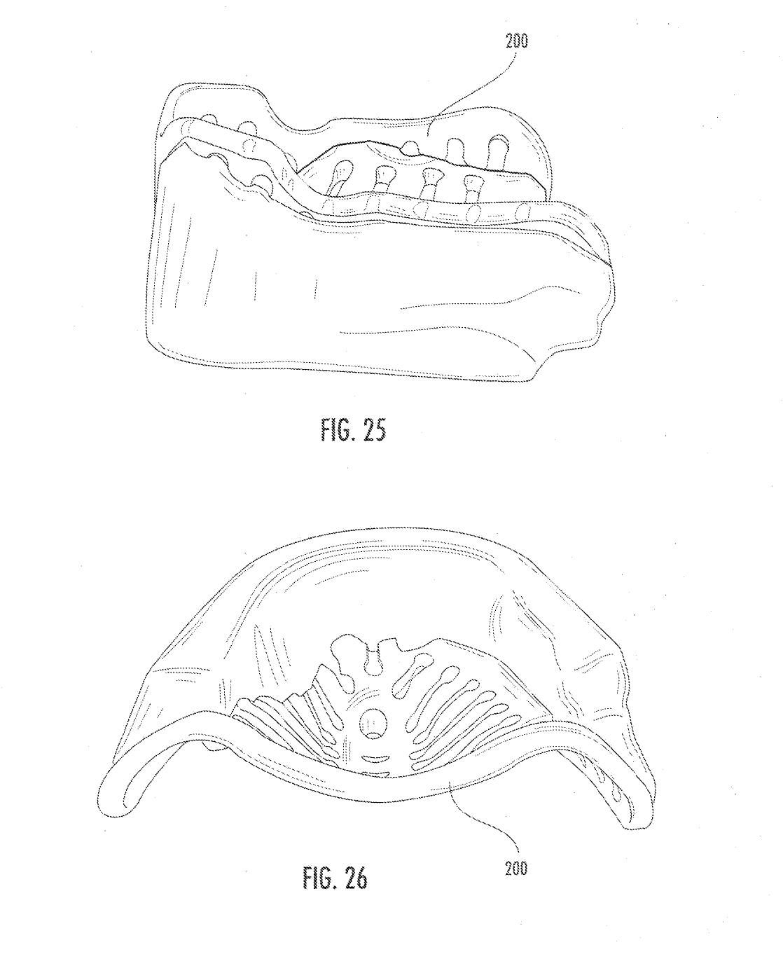

A third upper dental tray 200 as shown in FIGS. 23 through 26 with a wax or resin impression material 202 is inserted into the oral cavity of the patient for a procedure known as esthetic blue printing. The wax or resin impression material 202 may be preformed to fit on the third upper tray 200. If a second upper tray 120 is utilized for the esthetic blue printing procedure in lieu of the third tray, the strike plate is removed. During this procedure, the shape of the patient's upper lip and mouth are recognized and alter the soft wax or resin. The wax or resin may be a material which softens on heating. Accordingly, the impression material may be heated slightly prior to insertion into the oral cavity. Once the shape of the patient's upper lip and mouth is registered with the wax or resin material, the third upper tray 200 and wax impression material 202 are removed.

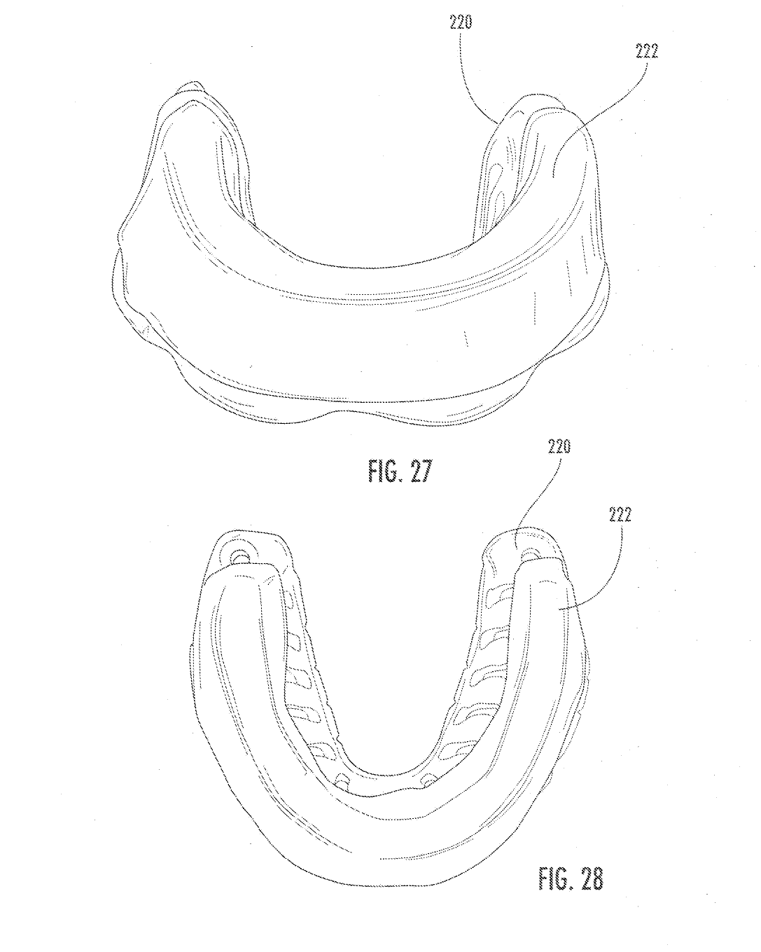

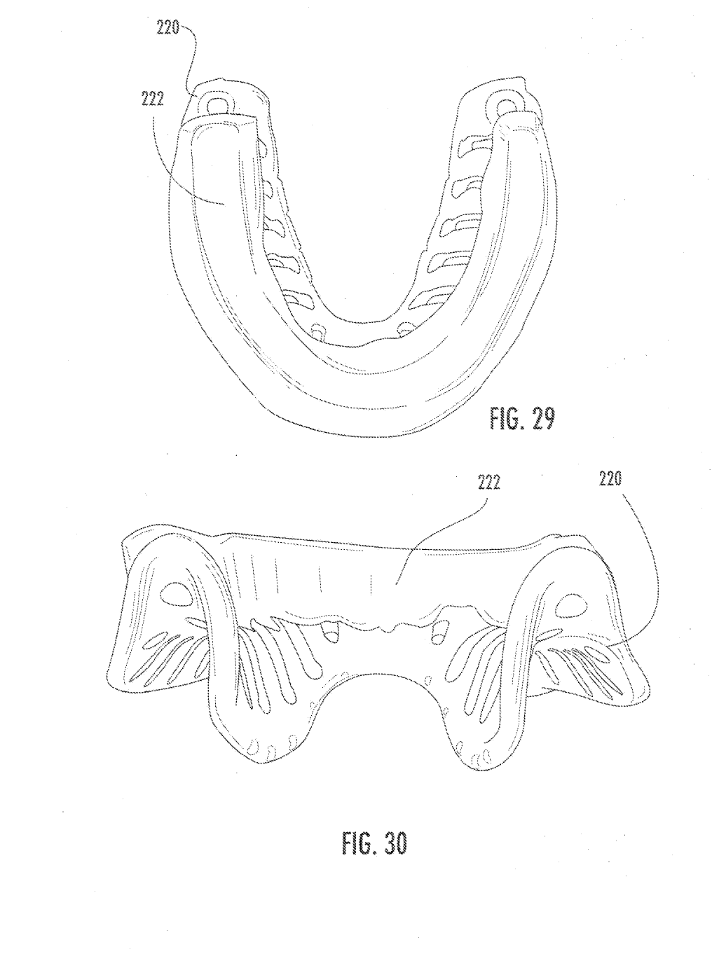

Either before the procedure with the third upper tray 200 or thereafter, a third, lower dental tray 220 with a wax or resin material 222 is inserted into the oral cavity of the patient in order to determine functional position including tongue, cheek and lip positioning as shown in FIGS. 27 through 30. The wax or resin impression material 222 may be preformed to fit on the third lower tray 200. If a second lower tray 100 is utilized for determining functional position in lieu of the third tray, the contact plate is removed. Once the functional positions have been registered and calibrated with the wax impression material 222, the third, lower dental tray 220 is removed.

Utilizing the foregoing sets of dental trays will provide measurements and calibrations in order to produce an accurate set of dentures. Following use of the sets of dental trays, the cast impression, which may be formed at any time following the use of the first set of dental trays, is combined with the second set of dental trays 100 and 120 used in the occlusal vertical and centric relation position along with a known articulator device (not shown) in order to determine positioning of the arches with respect to the jaw of the patient.

Through use of the method or process of the present invention, all of the foregoing measurements and calibrations may be taken in a single visit to a dentist or dental technician.

Whereas, the present invention has been described in relation to the drawings attached hereto, it should be understood that other and further modifications, apart from those shown or suggested herein, may be made within the spirit and scope of this invention.

What is claimed is:

1. A method for producing edentulous dentures, which method comprises:
obtaining a cast impression of a jaw, teeth and gingiva area in an oral cavity of a patient with a first set of dental trays including selecting a properly sized first upper dental tray and a properly sized first lower dental tray, applying impression material in each said tray, placing each said dental impression tray with said impression material in said oral cavity in order to deform uncured impression material, which causes said impression material to flow through a plurality of body openings in each said tray such that the impression material transfers to fill in any voids;
utilizing a second, lower dental tray with a contact plate attached thereto having an upwardly extending shoulder surrounding a tapered opening in said contact plate, a ball nut retained in said tapered opening, and a post adjustably secured to said ball nut and utilizing a second upper dental tray having a striking plate attached thereto to accurately obtain and establish occlusal vertical and centric relation positions;
utilizing a third upper dental tray with wax or resin impression material inserted into said oral cavity for esthetic blue printing to pick up the shape of the patient's upper lip and mouth; and
utilizing a third lower dental tray with wax or resin impression material thereon inserted into said oral cavity in order to determine functional position including tongue, cheek and lip positioning.

2. A method for producing edentulous dentures as set forth in claim 1 including the additional step of utilizing said cast impression obtained and said second lower and upper dental trays with an articulator device to determine positioning of the arches with respect to the jaw of the patient.

3. A method for producing edentulous dentures as set forth in claim 1 wherein said contact plate is removably attached to said second lower dental tray.

4. A method for producing edentulous dentures as set forth in claim 1 wherein said striking plate is removably attached to said second upper dental tray.

5. A method for producing edentulous dentures as set forth in claim 1 wherein said second upper dental tray is identical to said third upper dental tray.

6. A method for producing edentulous dentures as set forth in claim 1 wherein said second lower dental tray is identical to said third lower dental tray.

7. A method as set forth in claim 1 wherein said first upper dental tray and said first lower dental tray each include a body having an anterior end, a shelf section comprising an arcuate sheet of material and a handle section connected to said shelf section by a transition section.

8. A method for producing edentulous dentures, which method comprises:
obtaining a cast impression of a jaw, teeth and gingiva area using a first set of dental trays;
utilizing a second set of dental trays to accurately obtain and establish occlusal, vertical and horizontal positions, wherein said second set of dental trays includes:
(a) a contact plate attached to a lower dental tray having an upwardly extending shoulder surrounding a tapered opening in said contact plate, a ball nut retained in said tapered opening, and a post adjustably secured to said ball nut; and
(b) a striking plate attached to an upper dental tray, wherein the combination of the contact plate, said ball nut, and said post with said striking plate cooperate to obtain occlusal vertical dimension, centric relation position and other dental measurements;
utilizing a third upper dental tray inserted into said oral cavity with a wax impression for esthetic blue printing; and
utilizing a third lower dental tray inserted into said oral cavity with a wax impression to determine functional position.

9. A method for producing edentulous dentures as set forth in claim 8 including utilizing said cast impression and said second set of dental trays to determine positioning of the arches with respect to the jaw.
